(19) United States
(12) Patent Application Publication
(10) Pub. No.: US 2013/0103236 A1
(43) Pub. Date: Apr. 25, 2013

(54) USE OF SMARTPHONES, POCKET SIZE COMPUTERS, TABLETS OR OTHER MOBILE PERSONAL COMPUTERS AS THE MAIN COMPUTER OF COMPUTERIZED VEHICLES

(71) Applicant: BEHRANG MEHRGAN, RANCHO SANTA MARGARITA, CA (US)

(72) Inventor: BEHRANG MEHRGAN, RANCHO SANTA MARGARITA, CA (US)

(73) Assignee: BEHRANG MEHRGAN, RANCHO SANTA MARGARITA, CA (US)

(21) Appl. No.: 13/602,245

(22) Filed: Sep. 3, 2012

Related U.S. Application Data
(60) Provisional application No. 61/530,957, filed on Sep. 3, 2011.
(60) Provisional application No. 61/531,301, filed on Sep. 6, 2011.

(51) Int. Cl. G06F 19/00; B60W 20/00; G06Q 50/30; G05D 13/00; G05D 3/00; B60Q 1/00; B60T 7/00; G05D 1/00

(52) U.S. Cl. 701/22; 701/33.2; 701/82; 701/41; 701/23; 701/93; 701/45; 701/36; 701/51; 701/49; 701/123; 340/459; 340/441; 705/13

(57) ABSTRACT

This invention features a solution to use a pocket size pc, smartphone, or tablet or any other type of mobile personal computer as the main computer of a vehicle, in the highly computerized future vehicles. By connecting the smartphone/tablet/etc to the car interface, the phone/tablet/etc will become the brain of the machine, and acts as a vehicle computer system. By the use of the car manufacturer application software, or use of 3^{rd} party application software, It can be programmed for controlling/replacing many of the vehicle subsystems and accessories.

### BACKGROUND OF THE INVENTION

1. Field of Invention

This invention is in the field of the computer management of vehicles.

2. Description of the Related Art

Today we use so many products those have similar components and software. Mobile phones, GPS navigation systems, laptops, and desktop computers, all have processors, displays, and input devices (ex. Keyboard, touch pad, etc). The idea of using a smartphone to replace all the above mentioned devices was recently employed by Motorola. The Motorola Atrix smartphone can be called the first prototype. It's a smartphone. But when a laptop is needed, this mobile phone can be connected to a Laptop dock, which is actually a package including display, keyboard, touch pad, speakers, battery, and USB hub, but without a processor. By connecting the smartphone, the package will actually become a laptop. Even since the first marketed package does not work as good as a laptop, but the idea will grow in the future to build better packages.

Many of the above mentioned components can be seen on a vehicle computer too (On the computerized vehicles). Navigation systems are mainly being used in the new vehicles as an expensive option. Also the use of different microprocessors, ECU units and even computers on the vehicles is becoming more common. Vehicles with integrated computers are already in the market, mainly in the form of luxury cars. But the current integrated computers are normally very expensive due to high production costs. The integrated computers have to be able to work at extremely high and extremely low temperatures. Because the working temperature can reach to very low or high levels, especially when the vehicle is parked outdoor. They can be subjected to considerable shocks when driving, and should still work safely in tough conditions. All of these conditions increase the costs of a reliable on-board computer. Furthermore since the annual production is normally very low production costs can't be lowered.

In the other hand, best selling mobile phones are being produced in million of unites. IMS research expects the annual production of smartphones to reach to 1 billion units by 2016, which is higher than the number of the cars ever sold worldwide!! So cost prices of smart phones are lower than any other computer specially produced for vehicles. Mobile phones have no problem with the indoor shocks of a mass produced car. Also working temperature range is acceptable for this application, and temperature will not cause important problems, since the phone will be used inside the car, and is not likely to be left in the car for a very long time when the car is parked, especially because the driver should disconnect it from the interface for shutting the system down, and actually the key should not be left inside the car! Tablets have more and less the same structure of the smartphones.

So since the smartphones and tablets are becoming more advanced and powerful day by day, and considering the much more powerful devices are yet to come in the future, smartphones and tablets look very attractive, cheap and feasible solutions to replace the vehicles main computers and also some of the expensive parts (Like navigation system and music and radio player). Especially because most of the people already pay for the smartphones and tablets, and with this solution, they don't need to pay again for the expensive integrated car computers.

There have been efforts for using a cell phone for controlling a vehicle. Nearly in all the cases, the cell phone acts as a remote control, not a processing unit, and the vehicle has its own built in computer or processor. The main difference of this invention is that the smartpone/tablet/or other mobile computer can work as the main computer of the vehicle, or in some cases the auxiliary processing unit for the sub systems, and not just as a remote control.

Patent 2010/7725129 B2 5/2010 (cell phone based vehicle) published by Oliver David Grunhold (455/556.1) is a clear example of using a cell phone to control a vehicle as a remote control, when the vehicle has its own central processing module and a GPS.

Patent 2010/0075655 A1 3/2010 published by Jamie C howarter (455/420) provides methods for controlling vehicle systems from a cell phone and again the cell phone acts as a remote control system.

### BRIEF SUMMERY OF THE INVENTION

This invention features a solution to use a pocket size pc, smartphone, or tablet or any other type of mobile personal computer as the main computer of a computerized vehicle, in the highly computerized future vehicles. By connecting the smartphone/tablet/etc to the car interface, the phone/tablet/etc will become the brain of the machine.

By the vehicle manufacturer software, or use of 3^{rd} party application software, It can be programmed for controlling/replacing many of the vehicle subsystems and accessories, including display, traction control system, brakes management system, engine management system, hybrid and electric cars control unit, steering system management, lights management, auto pilot system, accident avoidance system, sound system (smartphone/tablet/etc can become the main music and radio/internet radio player, e-book reading device), AC or climate control, internet connection for the passengers, driver assistance systems, safety systems, monitoring and diagnosis system, vehicle's GPS navigation system, cruise control, red light running warning and avoidance system, speed limit violation avoidance system, stop sign violation avoidance system, speech and gesture recognition system, On-board black box/DVR, interactive user manual system, parking assistant system, monitoring system for tire pressure, pressure, an water temperature, games consoles, lane warning system, transmission monitoring and control, internet based application software for computerized vehicles, etc.

This invention can be used for some or all of the subsystems according to the vehicle producer's needs and safety concerns. Even in the highly computerized vehicles, there is a main on board computer, and then there are many independent microprocessors in order to control the independent sub systems (for example passive safety systems). Manufacturer may decide to keep the original microprocessors of many of the above mentioned systems. The main object of this invention is to replace the main computer, not all the microprocessors. But replacing all the micro processors is possible.

It can display all the system information and replacing odometer and various other gauges, and also will display the navigation system maps.

The multi touch capability of the screen, can lead to elimination of nearly all the handles and switches by making commands using various touch gestures.

The device is also capable of storing all the customized user profiles, including adjustments made on the driver's seat, mirrors, climate control system, driving modes like sport, comfort, economy, springs stiffness control (special vehicles, ex. Vehicles with hydro pneumatic suspension), etc. Storing the user profiles on the phone, is helpful when the driver intends to drive another vehicle, because as soon as sitting in the new vehicle, and connecting the smartphone/tablet/etc, after authorization, all the profile details can be applied on the new vehicle. Also if multiple drivers use the same vehicle, drivers will use their own phones. So each driver can have multiple user profiles.

by access to the vehicle's sensors, the smartphone/tablet/etc can provide accurate statistics about the system including fuel consumption graphs, and error codes, those can be stored, or printed later or even be sent to the manufacturer or service center through the internet.

The smartphone/tablet/etc will also replace the vehicles key in a highly secured way (ex. Use of password, pattern, gesture, pre-set code or even face or voice recognition technologies for start). If the required devices are available on the smartphone/tablet/etc, also fingerprint scan or eye scan methods can be used for starting the vehicle.

If required, An optional big auxiliary multi touch enabled screen, can be used as the main or secondary display of the system, and also as the input device.

The same pocket size pc can replace the passengers dedicated built in computers, through the built in monitors and keyboards provided for each seat, for Internet access, entertainment, gaming, and office works. Since gaming can slow down the smartphone/tablet/etc and make safety concerns, the system can be arranged to accept more than one removable processing unit in order to improve its processing capabilities.

By connecting a smartphone to the vehicle interface, It can also be used as a phone, whether as a handset, by the vehicles sound system, or by a Bluetooth headset. In case of wireless connection of the smartphone to the vehicle, the smartphone can also work independently as a phone.

This invention can be used for every type of vehicles including ground vehicles and also boats, and crafts.

### BRIEF DESCRIPTION OF THE SEVERAL VIEW OF THE DRAWING

FIG. 1: Shows the schematic view of the components.

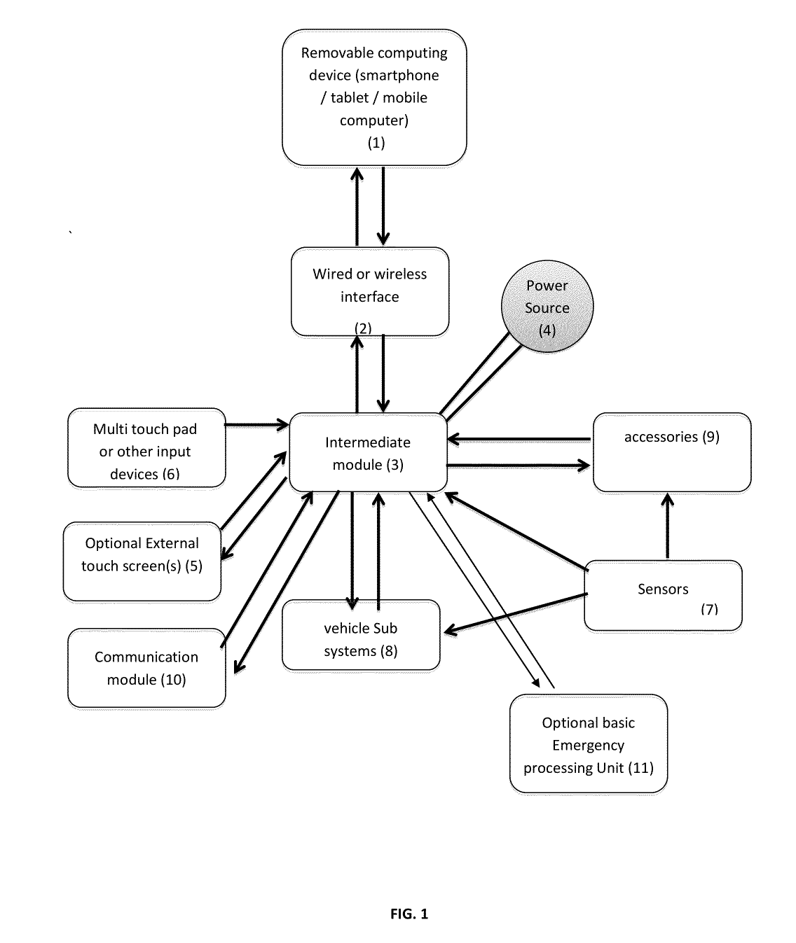

### DETAILED DESCRIPTION OF THE INVENTION

There is technically no difference in the working concept of a system with built in computer, and the structure of a system, with a removable smartphone/tablet/etc 1 as the main computer. The only difference is that since system analogue feedbacks are not recognizable for the removable computing device 1 (smartphone/tablet/mobile computer/etc), and the data produced by the removable processing device 1, is not understandable for the car components, an intermediate module 2 should be employed to translate the system feedback to data, and the removable processing device's data to the proper signals. The intermediate module 2 should include Analogue to digital converters, digital to analogue converters, Signal conditioners, communication chips, and high-level digital outputs (if required), a processor, etc. The intermediate module also needs a power source 4. Then there is an interface 3 required to connect the intermediate module to the removable processing device. This interface can be both in the form of wired or wireless connection. Wired connection also provides the possibility of charging the removable processing device 1. Use of a globally accepted interface will make it possible to use different brands of smartphones/tablets/etc, on the same vehicle. The interface(s) should also be able to connect external display and input devices. Motorola atrix has done it by connecting micro USB and HDMI ports at the same time. Similar solution can be used for this application too.

In case of employing the external auxiliary display 5 on the vehicle, the phone by itself can be used as the multi touch enabled touch pad too. Use of a multi touch enabled touch pad 6 is explained as another invention under application Ser. No. 61/529,271, where a multi touch enabled touch pad will enable the driver to make over 20 commands, by multi touch gestures when keeping the eyes on the road and without distraction.

The intermediate module, receives the system feedbacks from the sensors 7, the vehicles sub systems 8 and accessories 9, and sends the required signals to the subsystems 8 and accessories 9. The vehicle's independent microprocessors are considered as built in parts of the sub systems and have not been shown as independent units. The sequence of control between main computer and independent microprocessors can vary from vehicle to vehicle and depends on the manufacturer.

The communication module 10 includes modules for communications like modems and antennas, for example antenna for radio, because in case of using a smartphone as the radio of the system, it normally needs an external antenna for FM radio. At the meantime the smartphone needs no external antenna for the Internet radio.

For the emergency situations, like when the phone is lost, stolen, or broken, a key (a traditional key or a card key) can still start the vehicle. The independent microprocessors can work, and the vehicle can be designed in a way to perform as a basic car with no computerized features. An optional emergency processing unit 11 is shown to perform some basic operations in offline mode. Design of the system operation in offline mode is not an object of this invention.

1. A computerized vehicle, whereas the main computer of the vehicle is not a built in device and is a removable mobile computing device like a smartphone, a tablet computer or a pocket size or mobile computer, connected to the vehicle electric system through a wired or wireless interface and an intermediate module which translates the computing device data to the proper signals and electrical outputs for the vehicle subsystems, and the subsystem's feedbacks to data in order to be understandable for the computing device.

2. The computerized vehicle Subject of claim 1, where as the removable computing device has all or some of the features of modern smartphones and mobile computers like a built in GPS navigation system, digital compass, internet connectivity, Bluetooth connection, wifi connection, built in camera, multi touch screen (and gesture recognition), accelerometer, memory, processor, Operating system, battery, etc.

3. The computerized vehicle Subject of the claim 2, whereas the removable computing device employs different application software in order to get feedback from the vehicle sensors and subsystems through the intermediate module, process the related data and monitor, control or even simulate some or all of the software based subsystems of the vehicle like traction control system, brakes management system, engine management system, hybrid or electric cars control unit, steering system management system, lights management system, auto pilot system for ground and non ground vehicles, accident avoidance system, sound system including music player, radio, internet radio player and e-book reading application software, AC or climate control management system, driver assistance systems, active and passive safety systems, monitoring and diagnosis system, vehicle's GPS navigation system, cruise control, red light running warning system, red light running avoidance system, speed limit violation warning and avoidance system, stop sign violation warning and avoidance system, speech and gesture recognition system, On-board black box/DVR, interactive user manual system, parking assistant system, Tire pressure monitoring system, games consoles, lane warning, transmission monitoring and control, internet based applications for computerized vehicles, odometer, gauges, etc.

4. The computerized vehicle Subject of claim 3 whereas the display of the removable computing device displays all the system information and replacing odometer and various gauges, and also displays the navigation system maps.

5. The computerized vehicle Subject of claim 3 whereas the built in and attachable input devices of the removable computing devices for example multi touch screen, microphone, camera, and Bluetooth touchpad can lead to elimination of nearly all the handles and switches of the vehicle, by meant of touch, multi touch gestures, hand and face gestures, and voice recognition.

6. The computerized vehicle Subject of claim 3 whereas The computing device is also capable of storing all the customized user settings as user profiles, including adjustments made on the driver's seat, mirrors, climate control system, driving modes like sport, comfort, economy, springs stiffness control, and apply the chosen profile to the vehicle(s) that one driver drives.

7. The computerized vehicle having a red light running alert system, whereas an application software uses the navigation system information in order to predict the next in rout intersections, connects to the police department using the internet connection of the device, gets the current status and live timing information of the next red lights, and considering the car location, orientation, current speed, driver behavior, and predicted speed, predicts if the vehicle is about to run the red light and makes visual and/or audible warnings through the vehicle displays, lights, and sound system.

8. The computerized vehicle subject to claim 7 having a red light running avoidance system, whereas in case of predicting the red light running, the computing device prevents cruising, activates the brakes, and prevents the vehicle from entering the intersection, by stopping it smoothly before entering the intersection, or reduces the speed to a safe level to make a right turn, and does not stop the car if it predicts that the driver is making a right turn, considering the data obtained from the signal lights, steering system, position and orientation of the car, and camera images analysis.

9. The red light avoidance system subject of claim 9, whereas the system can be turned off intentionally by the driver for an unlimited time or temporarily by a single gesture touch of the input devices in case that the driver feels that the system has made the wrong prediction.

10. The computerized vehicle subject of claim 3 with a speed limit violation avoidance system, which uses the GPS navigation system and internet based resources to detect the legal speed, and odometer information in order to detecting the violation and makes audible and visual alarms and can control the brakes and cruise system in order to keep the speed in legal level unless the driver turns the features partly or completely off intentionally for an unlimited period or temporarily.

11. The computerized vehicle subject of claim 3 with a stop sign running avoidance system, whereas an application software uses the GPS navigation system maps and internet resources in order to detect the in rout stop signs, and predicts if the vehicle speed is going to be too high to be stopped before the stop sign, and makes audible and visual alarms and can control the brakes and cruise system in order to avoid stop sign running unless the driver turns the feature partly or completely off intentionally for an unlimited time or temporarily.

12. The computerized vehicle subject of claim 3 with black box / car DVR feature, whereas the removable computing device can record the system behavior as a black box, and using the mobile computer built in camera or cameras can record the surrounding events up to a specific memory capacity to be rewritten continuously, and using the device's built in accelerometer in order to detect accidents and save the captured videos for a specific period of time before and after the crash and also take a few high quality photos just after the crash.

13. The computerized vehicle subject of claim 3 whereas the computing device, by access to the vehicle's sensors can provide accurate statistics about the system like fuel consumption and performance graphs, and error codes, those can be stored, or printed later or even be sent to the manufacturer or service center through the internet for diagnosis and trouble shooting.

14. The computerized vehicle subject of claim 3, whereas the removable computing device will replace the vehicles key by the use of secured once defined secure pairing, password, pattern, gesture, pre-set code, face or voice recognition technologies, or fingerprint or eye scan for start and each mobile computing device can be set to be used with different vehicles, and each vehicle can be set to work with different computing devices of different drivers.

15. The computerized vehicle subject of claim 3 whereas optional auxiliary displays and input devices are employed for driver or other passengers.

16. The computerized vehicle subject of claim 3 whereas using antitheft internet based application software, both vehicle and computing device can be remotely locked and/or located on the map.

17. The computerized vehicle subject of claim 3, whereas the computing device has an interactive operator's manual application software, and after pairing with each car, gets the vehicles information including make, model, production year, from a built in chip, and download the related manual files from a database on the internet to be available offline for the driver at any time.

18. The computerized vehicle subject of claim 3, whereas a mobile computing device can be authorized to drive the car for a limited time, or can be unauthorized by the owner after a period of time in case of lending the car to someone for a limited time.

19. The computerized vehicle subject of claim 3, whereas the said vehicle has at least one independent auxiliary built in microprocessor for the subsystem(s) not covered by the removable computing device processor, decided by the vehicle manufacturer for reasons like safety, reliability, etc.

20. The computerized vehicle subject of claim 3, whereas the vehicle can be turned on with a traditional key in case of emergency and work only as a basic car without features provided by the removable computing device.

21. The computerized vehicle subject of claim 3, with parking meter application software, whereas the said application software can arrange online payments, and can be set to do timely payments until a specific time or unless it detects that the computing device has been paired with the vehicle, the vehicle has been turned on and moved out of the parking, and also automatically arranges the refund of the extra money paid, if the vehicle moves out of the parking early.

22. The computerized vehicle subject of claim 3, whereas the used computing device has a “drive mode”, that activates a processing management software, in order to give the highest processing priority to the processes related to vehicle drive systems, and use the additional available processing capacity for other activities and application software, and prevents unnecessary and unauthorized applications from working.
